(19) United States
(12) Patent Application Publication
(10) Pub. No.: US 2011/0157501 A1
(43) Pub. Date: Jun. 30, 2011

(54) POLYMER NETWORK LIQUID CRYSTAL DRIVING APPARATUS AND DRIVING METHOD, AND POLYMER NETWORK LIQUID CRYSTAL PANEL

(75) Inventors: Minoru USUI, Fussa-shi (JP); Ryuichi Hirayama, Musashimurayama-shi (JP); Naoki Inagaki, Hamura-shi (JP)

(73) Assignee: CASIO COMPUTER CO., LTD., Tokyo (JP)

(21) Appl. No.: 12/962,892

(22) Filed: Dec. 8, 2010

(30) Foreign Application Priority Data
Dec. 25, 2009 (JP) 2009-295896

(51) Int. Cl. G02F 1/1333

(52) U.S. Cl. 349/33; 349/88

(57) ABSTRACT

When a signal, which is switched between a first level (0 V) and a second level (Vseg) in a predetermined cycle, is input to a common electrode and respective segment electrodes of a plurality of polymer network (PN) liquid crystal display elements to be subjected to static driving, the plurality of PN liquid crystal display elements are divided into two or more groups. The level switching of a signal (SEG-A) that is output to the segment electrode of the PN liquid crystal display element included in one group and the level switching of a signal (SEG-B) that is output to the segment electrode of the PN liquid crystal display element as each signal output to the respective segment electrodes of the plurality of PN liquid crystal display elements are performed at timings that do not overlap each other.

### CROSS-REFERENCE TO RELATED APPLICATIONS

This application is based upon and claims the benefit of priority from prior Japanese Patent Application No. 2009-295896, filed Dec. 25, 2009, the entire contents of which are incorporated herein by reference.

### BACKGROUND OF THE INVENTION

1. Field of the Invention

The present invention relates to a driving apparatus and a driving method configured to drive a polymer network liquid crystal display element, and to a polymer network liquid crystal panel having such a driving apparatus mounted thereon.

2. Description of the Related Art

A liquid crystal display element is used for display panels having various uses because of its features, e.g., a small thickness or small power consumption. As a general display mode of the liquid crystal display element, there is known, e.g., a twisted nematic mode which is a method of displaying an image by controlling an amount of light transmitted through two polarizing plates in lights emitted from a backlight as a light source by using a liquid crystal panel having a configuration that a liquid crystal layer is sandwiched between the two polarizing plates. However, the polarizing plates have high optical absorptance and, when using the polarizing plates, a bright light source is needed to realize bright display, thus requiring more energy.

On the other hand, there is known such a polymer network liquid crystal display element as disclosed in, e.g., Jpn. Pat. Appln. KOKAI Pub. No. 2003-270657. This polymer network liquid crystal display element can control display by controlling alignment of liquid crystal molecules in a liquid crystal layer dispersed in a polymer network by using an electric field generated by electrodes arranged to sandwich the liquid crystal layer therebetween and thereby changing the liquid crystal layer between a light transmitting state and a light scattering state.

A driving method for a polymer network liquid crystal display element based on a static driving system will now be described. It is assumed that one of electrodes arranged to sandwich a liquid crystal layer of the polymer network liquid crystal display element therebetween is a common electrode, the other is a segment electrode, a common electrode driving waveform is COM, a display-on segment electrode waveform is SEG ON, and a display-off segment electrode waveform is SEG OFF. Each of waveforms COM, SEG ON, and SEG OFF is a square wave whose maximum value corresponds to a voltage Vseg and whose minimum value corresponds to 0 V (ground voltage).

The display-on segment electrode waveform SEG ON has a reverse phase with respect to the common electrode driving waveform COM. At this moment, a large voltage (an effective value) is applied to the polymer network liquid crystal display element to enter a display-on state. In this display-on state, the liquid crystal layer turns to the light transmitting state, i.e., a transparent state. In case of the polymer network liquid crystal, the liquid crystal layer generally turns on in response to a voltage of approximately 5 V. In contrast, the display-off segment electrode waveform SEG OFF is in-phase with respect to the common electrode driving waveform COM. At this moment, no voltage (effective value) is applied to the polymer network liquid crystal display element to enter a display-off state. In this display-off state, the liquid crystal layer enters the light scattering state, i.e., a diffusing state.

In such a polymer network liquid crystal display element, since polarizing plates are not required, a light loss due to absorption of the polarizing plates does not occur, and light can be effectively used. Therefore, bright display can be performed.

As described above, even in the polymer network liquid crystal, since a level of an application voltage must be switched to carry out alternating-current driving, the polymer network liquid crystal driving apparatus switches the common electrode driving waveform COM from a first level to a second level or from the second level to the first level in an alternating-current cycle, and it switches the segment electrode waveform SEG to have the same phase or the reverse phase with respect to a common electrode driving waveform COM signal depending on whether display contents are in the diffusing state (SEG OFF state) or the transparent state (SEG ON state) at the same timing as the common electrode driving waveform COM, thereby performing switching output from the first level to the second level or from the second level to the first level.

In the polymer network liquid crystal panel on which many polymer network liquid crystal display elements described above are arranged, all the polymer network liquid crystal display elements enter the same display state, for example. In such a case, since switching directions of the segment electrode waveforms SEG are the same, electro-current concentration during switching is intensive.

On the other hand, when manufacturing a polymer network liquid crystal panel in which the polymer network liquid crystal driving apparatus is formed as an LSI to be chip-on-glass (COG)-mounted on a liquid crystal panel glass, many interconnect patterns must be arranged in a limited space. In this polymer network liquid crystal panel, increasing the number of segments of a polymer network liquid crystal to be mounted and narrowing a frame are demanded. Therefore, each interconnect pattern becomes thin, each gap between the interconnect patterns adjacent to each other also becomes very small, and interconnect resistance increases.

When a large current flows through each interconnect pattern having the large resistance during switching as described above, the voltage drop becomes considerable, a sufficient driving voltage cannot be applied to the polymer network liquid crystal, and a problem that a desired display state cannot be obtained occurs. Therefore, narrowing the frame of the polymer network liquid crystal panel having the polymer network liquid crystal driving apparatus COG-mounted on the liquid crystal panel glass is desired, but its achievement is difficult.

### BRIEF SUMMARY OF THE INVENTION

An aspect of a polymer network liquid crystal driving apparatus according to the invention includes:

means for dividing a plurality of polymer network liquid crystal display elements into two or more groups when inputting a signal, which is switched between a first level and a second level in a predetermined cycle, to a common electrode and respective segment electrodes of the plurality of polymer network liquid crystal display elements to be subjected to static driving; and

output means for outputting to the respective segment electrodes of the plurality of polymer network liquid crystal display elements a signal that performs at non-overlapping timings switching of the level of a signal which is output to the segment electrode of the polymer network liquid crystal element included in one group and switching of the level of a signal which is output to the segment electrode of the polymer network liquid crystal display element included in another group.

An aspect of a polymer network liquid crystal driving method according to the invention includes:

a step of dividing a plurality of polymer network liquid crystal display elements into two or more groups when inputting a signal, which is switched between a first level and a second level in a predetermined cycle, to a common electrode and respective segment electrodes of the plurality of polymer network liquid crystal display elements to be subjected to static driving; and

a timing control step of performing at non-overlapping timings switching of the level of a signal which is output to the segment electrode of the polymer network liquid crystal element included in one group and switching of the level of a signal which is output to the segment electrode of the polymer network liquid crystal display element included in another group as a signal that is output to the respective segment electrodes of the plurality of polymer network liquid crystal display element.

An aspect of a polymer network liquid crystal panel according to the invention includes:

a transparent substrate;

a plurality of polymer network liquid crystal display elements formed on the transparent substrate; and

a polymer network liquid crystal driving apparatus that inputs a signal, which is switched between a first level and a second level in a predetermined cycle, to a common electrode and respective segment electrodes of the plurality of polymer network liquid crystal display elements to be subjected to static driving,

wherein the polymer network liquid crystal driving apparatus divides the plurality of polymer network liquid crystal display elements into two or more groups, and outputs to the respective segment electrodes of the plurality of polymer network liquid crystal display elements a signal that performs at non-overlapping timings switching of the level of a signal which is output to the segment electrode of the polymer network liquid crystal element included in one group and switching of the level of a signal which is output to the segment electrode of the polymer network liquid crystal display element included in another group.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a timing chart showing applied voltage waveforms during display-on in a polymer network liquid crystal driving apparatus and driving method according to a first embodiment of the present invention;

FIG. 1B is a timing chart likewise showing applied voltage waveforms during display-off;

FIG. 2A is a view for explaining an operation of a polymer network liquid crystal display element when no voltage is applied;

FIG. 2B is a view for explaining an operation of the same when a voltage is applied;

FIG. 3A is a view showing a light path of a single-lens reflex camera for explaining an application example of the polymer network liquid crystal panel according to the first embodiment of the present invention;

FIG. 3B is a view showing an example of display in a viewfinder;

FIG. 3C is a view for explaining a structural example of the polymer network liquid crystal panel;

FIG. 3D is a view for explaining a structural example of the polymer network liquid crystal panel;

FIG. 4A is a timing chart showing applied voltage waveforms during display-on in a polymer network liquid crystal driving apparatus and driving method according to a second embodiment of the present invention;

FIG. 4B is a partially enlarged view of FIG. 4A;

FIG. 4C is a timing chart showing applied voltage waveforms during display-off in the polymer network liquid crystal driving apparatus and driving method according to the second embodiment;

FIG. 4D is a partially enlarged view of FIG. 4C;

FIG. 5A is a timing chart showing applied voltage waveforms during display-on in a polymer network liquid crystal driving apparatus and driving method according to a third embodiment of the present invention; and

FIG. 5B is a timing chart likewise showing applied voltage waveforms during display-off.

### DETAILED DESCRIPTION OF THE INVENTION

### First Embodiment

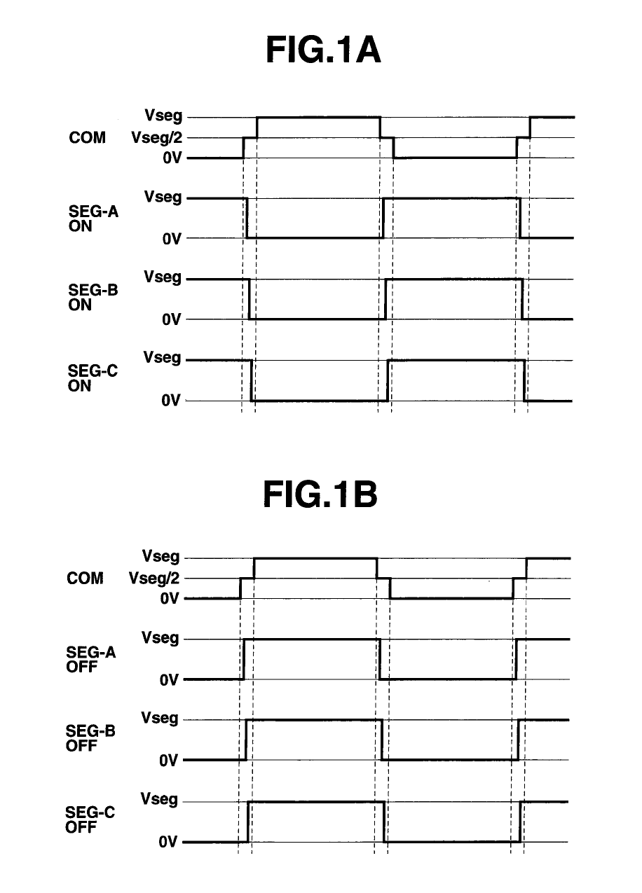

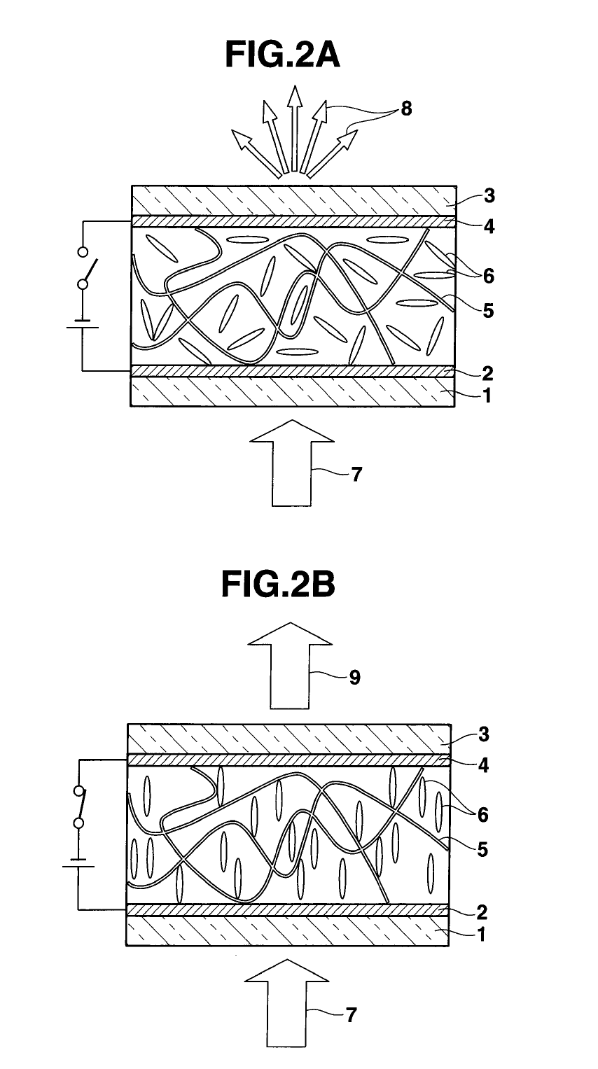

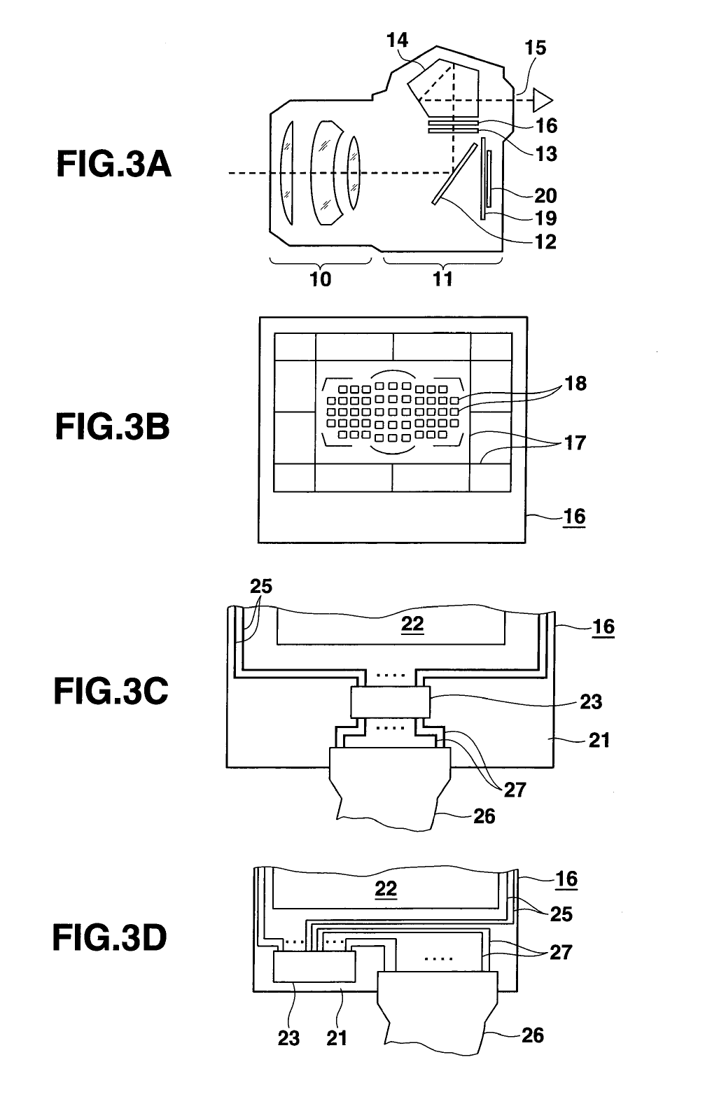

A first embodiment according to the present invention will now be described hereinafter with reference to FIG. 1A, FIG. 1B, FIG. 2A, FIG. 2B, FIG. 3A, FIG. 3B, FIG. 3C, and FIG. 3D. Here, FIG. 1A is a timing chart showing applied voltage waveforms during display-on in a polymer network (which will be referred to as PN hereinafter) liquid crystal driving apparatus and driving method according to this first embodiment, and FIG. 1B is a timing chart likewise showing applied voltage waveforms during display-off. Further, FIG. 2A is a view for explaining an operation of the PN liquid crystal display element when no voltage is applied, and FIG. 2B is a view for explaining an operation of the same when a voltage is applied. Furthermore, FIG. 3A is a view showing a light path of a single-lens reflex camera for explaining an application example of the PN liquid crystal panel according to this first embodiment, FIG. 3B is a view showing an example of display in a viewfinder, and each of FIG. 3C and FIG. 3D is a view for explaining a structural example of the PN liquid crystal panel.

As shown in FIG. 2A, in a PN liquid crystal display element, a common electrode 2 constituted by forming a transparent conductive film such as an indium tin oxide (ITO) film is formed on a light source-side transparent substrate 1 such as a glass substrate. Moreover, a segment electrode 4 constituted of, e.g., an ITO film is formed on an observation-side transparent substrate 3 which is a transparent substrate such as a glass substrate. Additionally, the common electrode 2 side of the light source-side transparent substrate 1 and the segment electrode 4 side of the observation-side transparent substrate 3 are bonded through a non-illustrated gap material to form a uniform gap. A liquid crystal layer configured to have liquid crystal molecules 6 dispersed in a PN 5 is put in this gap.

In such a configuration, when an electric field is not formed between the common electrode 2 and the segment electrode 4 as shown in FIG. 2A, the liquid crystal molecules 6 dispersed in the PN 5 face arbitrary directions. In this case, when a refractive index of the PN 5 and an average refractive index of the liquid crystal molecules 6 are set to be different from each other, incident light 7 that has entered from the light source-side transparent substrate 1 side passes through the liquid crystal layer while scattering, and the scattering light 8 exits from the observation-side transparent substrate 3. Therefore, the light that has entered the liquid crystal layer in which the liquid crystal molecules 6 face arbitrary directions exits from observation-side transparent substrate 3 side while scattering, and hence this light is observed as clouded light from the observation-side transparent substrate 3 side.

On the other hand, as shown in FIG. 2B, in a state where a large electric field is formed between the common electrode 2 and the segment electrode 4, the liquid crystal molecules 6 dispersed in the PN 5 are aligned in one direction in accordance with the generated electric field. In this case, when the refractive index of the PN 5 and the refractive index of the liquid crystal molecules 6 aligned in one direction are set to be equal to each other, the incident light 7 that has entered from the light source-side transparent substrate 1 side travels straight in the liquid crystal layer and exits from the observation-side transparent substrate 3 as transmitted light 9. Since the light that has entered the liquid crystal layer in which the liquid crystal molecules 6 are aligned in one direction straightly exits from the observation-side transparent substrate 3 side, namely, since the PN liquid crystal display element enters a transparent state, the light that has entered the PN liquid crystal display element is observed as it is from the observation-side transparent substrate 3 side.

In this manner, the PN liquid crystal display element can control display by controlling the alignment of the liquid crystal molecules 6 in the liquid crystal layer dispersed in the PN 5 by using the electric field generated by the common electrode 2 and the segment electrode 4 arranged to sandwich the liquid crystal layer and changing the liquid crystal layer to the light transmitting state and the light scattering state. It is to be noted that the common electrode 2 is formed on the light source-side transparent substrate 1 and the segment electrode 4 is formed on the observation-side transparent substrate 3 in the examples depicted in FIG. 2A and FIG. 2B, but of course the segment electrode 4 can be formed on the light source-side transparent substrate 1 and the common electrode 2 can be formed on the observation-side transparent substrate 3.

When the plurality of such PN liquid crystal display elements are arranged as segments to form a PN liquid crystal panel, the light source-side transparent substrate 1 and the observation-side transparent substrate 3 are shared, the solid common electrode 2 is uniformly formed on the light source-side transparent substrate 1 without space, and the liquid crystal layers and the segment electrodes 4 are arranged in desired shapes.

For example, as shown in FIG. 3A and FIG. 3B, the formed PN liquid crystal panel can be applied for display in a viewfinder of a single-lens reflex camera. In the single-lens reflex camera, as shown in FIG. 3A, light from a subject is led into a camera main body 11 through a lens 10 and reflected by a mirror 12 to form a real image of the subject on a ground glass 13. This subject image is led to a viewfinder 15 through a pentaprism 14 so that it can be observed. A PN liquid crystal panel 16 according to this embodiment is arranged between the ground glass 13 and the pentaprism 14 to display various kinds of information to be superimposed on the real image reflected on the ground glass 13. For example, such composition grid lines 17 or focus point indicators 18 (51 indicators in this example) as depicted in FIG. 3B are included as such information, and the liquid crystal layer and the segment electrode 4 of the PN liquid crystal display element are formed in accordance with each shape of these members. Of course, any other information such as a camera mode or a remaining battery level can be displayed. When each PN liquid crystal display element is set to the display-off state, the liquid crystal layer enters the light scattering state, and information is displayed in white to be superimposed on the real image reflected on the ground glass 13.

It is to be noted that, since shooting is performed by moving up the mirror 12 and opening a shutter 19 to lead subject light to a film or an imaging element 20 in the single-lens reflex camera, the subject image is not led to the PN liquid crystal panel 16 in a mirror-up state, and the information displayed in the PN liquid crystal panel 16 alone is observed in the viewfinder 15.

In the PN liquid crystal panel 16, as shown in FIG. 3C, a display unit 22 and an actuation driver 23 are COG-mounted on a liquid crystal panel glass 21. Here, a plurality of PN liquid crystal display elements are arranged in the display unit 22, and the liquid crystal panel glass 21 is used as the light source-side transparent substrate 1. The actuation driver 23 is a PN liquid crystal driving device formed as an LSI to drive each PN liquid crystal display element, and an interconnect pattern 25 configured to feed power to the segment electrode 4 of each PN liquid crystal display element or the shared common electrode 2 from the actuation driver 23 is formed on the liquid crystal panel glass 21. Additionally, interconnect patterns 27 that connect a flexible substrate 26 by ACF connection method using an anisotropic conductive film are also formed on the liquid crystal panel glass 21. The flexible substrate 26 supplies a control signal and others from a non-illustrated camera control unit configured in the camera main body 11 to the PN liquid crystal panel 16.

In this PN liquid crystal panel 16, when achieving a narrow frame, such an arrangement configuration as depicted in FIG. 3D is adopted. That is, the actuation driver 23 and a non-illustrated connector section for ACF connection are arranged side by side, and the interconnect patterns 25 and 27 are thinned and drawn in proximity to interconnect patterns adjacent to each other. The thinning and the proximal arrangement of the interconnect patterns 25 and 27 do not cause a problem when the number of the PN liquid crystal display elements, i.e., the number of segments in the display unit 22 is several to ten or more, but the number of segments exceeds 100 and large interconnect resistance is provided when these segments are applied to a display in the viewfinder of such a single-lens reflex camera as depicted in FIG. 3A and FIG. 3B. Further, since all the segments must be set in the same display state, during switching a level of a segment electrode waveform by switching a level of an applied voltage to effect alternating-current driving, a large current flows through the interconnect pattern 25 having such large interconnect resistance, and a driving voltage greatly drops. As a result, a voltage that is sufficient to provide a desired display state cannot be applied to each PN liquid crystal display element, and the desired display state cannot be obtained.

Thus, in this embodiment, the actuation driver 23 performs such driving as shown in FIG. 1A and FIG. 1B.

That is, a common electrode driving waveform COM applied to the common electrode 2 is a square wave wherein 0 V (ground voltage) which is a minimum value as a first level and a voltage Vseg (e.g., 5 V) which is a maximum value as a second level are switched in a predetermined cycle in a conventional example, but a signal state of an intermediate level (Vseg/2) between the first level and the second level is temporarily output for a predetermined time at the timing of the level switching.

Further, many PN liquid crystal display elements arranged in the display unit 22 are divided into two or more groups (three groups A to C in this embodiment), and level switching of segment electrode waveforms SEG-A, SEG-B, and SEG-C applied to the segment electrodes in the respective groups that is performed in the same cycle as the common electrode driving waveform COM is carried out while the common electrode driving waveform COM is on the intermediate level in such a manner that timings for the respective waveforms do not overlap each other. The number of the groups determines the predetermined time for which the common electrode driving waveform COM is set to the signal state of the intermediate level.

Specifically, in display-on (transparent state), as shown in FIG. 1A, at a level switching timing for switching the common electrode driving waveform COM from 0 V as the first level to voltage Vseg as the second level, the common electrode driving waveform COM is first switched to a voltage Vseg/2 which is the intermediate level from 0 V as the first level. Then, segment electrode waveform SEG-A which is applied to the segment electrodes 4 of the PN liquid crystal display elements belonging to the first group A is switched from voltage Vseg to 0 V. At this time, segment electrode waveforms SEG-B and SEG-C that are applied to the segment electrodes 4 of the PN liquid crystal display elements belonging to the second and third groups B and C remain at voltage Vseg. Subsequently, segment electrode waveform SEG-B is switched from voltage Vseg to 0 V. At this time, segment electrode waveform SEG-A remains as 0 V, and segment electrode waveform SEG-C remains at voltage Vseg. Then, segment electrode waveform SEG-C is switched from voltage Vseg to 0 V. At this time, segment electrode waveforms SEG-A and SEG-B remain at 0 V. After segment electrode waveforms SEG-A, SEG-B, and SEG-C are all switched to 0 V, the common electrode driving waveform COM is switched from voltage Vseg/2 as the intermediate level to voltage Vseg as the second level.

Furthermore, at the next level switching timing for the common electrode driving waveform after elapse of the predetermined cycle, the common electrode driving waveform COM is first switched from voltage Vseg as the second level to voltage Vseg/2 as the intermediate level. Then, segment electrode waveform SEG-A is switched from 0 V to voltage Vseg. At this time, segment electrode waveforms SEG-B and SEG-C remain at 0 V. Then, segment electrode waveform SEG-B is switched from 0 V to voltage Vseg. At this time, segment electrode waveform SEG-A remains at voltage Vseg, and segment electrode waveform SEG-C remains as 0 V. Thereafter, segment electrode waveform SEG-C is switched from 0 V to voltage Vseg. At this time, segment electrode waveforms SEG-A and SEG-B remain at voltage Vseg. After segment electrode waveforms SEG-A, SEG-B, and SEG-C are all switched to voltage Vseg, the common electrode driving waveform COM is switched from voltage Vseg/2 as the intermediate level to 0 V as the first level.

The above-described level switching operations are alternately performed.

Moreover, display-off (diffusing state), as shown in FIG. 1B, at a level switching timing for the common electrode driving waveform COM, the common electrode driving waveform COM is first switched from 0 V as the first level to voltage Vseg/2 as the intermediate level. Thereafter, segment electrode waveform SEG-A is switched from 0 V to voltage Vseg. At this time, segment electrode waveforms SEG-B and SEG-C remain at 0 V. Subsequently, segment electrode waveform SEG-B is switched from 0 V to voltage Vseg. At this time, segment electrode waveform SEG-A remains at voltage Vseg, and segment electrode waveform SEG-C remains as 0 V. Then, segment electrode waveform SEG-C is switched from 0 V to voltage Vseg. At this time, segment electrode waveforms SEG-A and SEG-B remain at voltage Vseg. After segment electrode waveforms SEG-A, SEG-B, and SEG-C are all switched to voltage Vseg in this manner, the common electrode driving waveform COM is switched from voltage Vseg/2 as the intermediate level to voltage Vseg as the second level.

Further, after elapse of the predetermined cycle, at the next level switching timing for the common electrode driving waveform COM, the common electrode driving waveform COM is first switched from voltage Vseg as the first level to voltage Vseg/2 as the intermediate level. Then, segment electrode waveform SEG-A is switched from voltage Vseg to 0 V. At this time, segment electrode waveforms SEG-B and SEG-C remain at voltage Vseg. Subsequently, segment electrode waveform SEG-B is switched from voltage Vseg to 0 V. At this time, segment electrode waveform SEG-A remains as 0 V, and segment electrode waveform SEG-C remains at voltage Vseg. Thereafter, segment electrode waveform SEG-C is switched from voltage Vseg to 0 V. At this time, segment electrode waveforms SEG-A and SEG-B remain at 0 V. After segment electrode waveforms SEG-A, SEG-B, and SEG-C are all switched to 0 V in this manner, the common electrode driving waveform COM is switched from voltage Vseg/2 as the intermediate level to 0 V as the first level.

The above-described level switching operations are alternately carried out.

Therefore, the actuation driver 23 is the PN liquid crystal driving apparatus that inputs each signal which is switched between the first level and the second level in the predetermined cycle to the common electrode 2 and the respective segment electrodes 4 of the plurality of PN liquid crystal display elements to carry out static driving, and it functions as the PN liquid crystal driving apparatus that divides the plurality of PN liquid crystal display elements into two or more groups and outputs to the respective segment electrodes 4 of the plurality of PN liquid crystal display elements each signal which is utilized to perform at non-overlapping timings the level switching of each signal output to the segment electrode 4 of the PN liquid crystal display element included in one group and the level switching of each signal output to the segment electrode 4 of the PN liquid crystal display element included in another group.

Moreover, in this first embodiment, this actuation driver 23 as the PN liquid crystal display apparatus outputs a signal state of the intermediate level between the first level and the second level from a signal state of the first or second level as each signal output to the common electrode during the level switching for switching from the first level to the second level or from the second level to the first level, then outputs a signal that enters a signal state of the second or first level, and performs the level switching of each signal output to the segment electrode when the signal output to the common electrode is in the signal state of the intermediate level.

Additionally, the PN liquid crystal panel 16 functions as the PN liquid crystal panel that includes: the liquid crystal panel glass 21 as the transparent substrate; the plurality of PN liquid crystal display elements formed on the transparent substrate; and the actuation driver 23 as the PN liquid crystal driving apparatus according to this embodiment that is COG-mounted on the transparent substrate.

When the PN liquid crystal driving method according to this first embodiment is adopted, a current flowing during level switching of the driving waveform in the static driving system can be dispersed, namely, electro-current concentration can be suppressed, whereby a drop of the driving voltage due to a large current during the level switching can be reduced. Therefore, since a voltage that is sufficient to provide a desired display state can be applied to the PN liquid crystal display element, a narrow-frame PN liquid crystal panel having the actuation driver 23, which is formed as an LSI, COG-mounted on the liquid crystal panel glass 21 can be manufactured.

Further, effective voltages during the driving waveform level switching can be uniformed in the respective groups by temporarily outputting the common electrode driving waveform COM to the intermediate level.

### Second Embodiment

A second embodiment according to the present invention will now be described with reference to

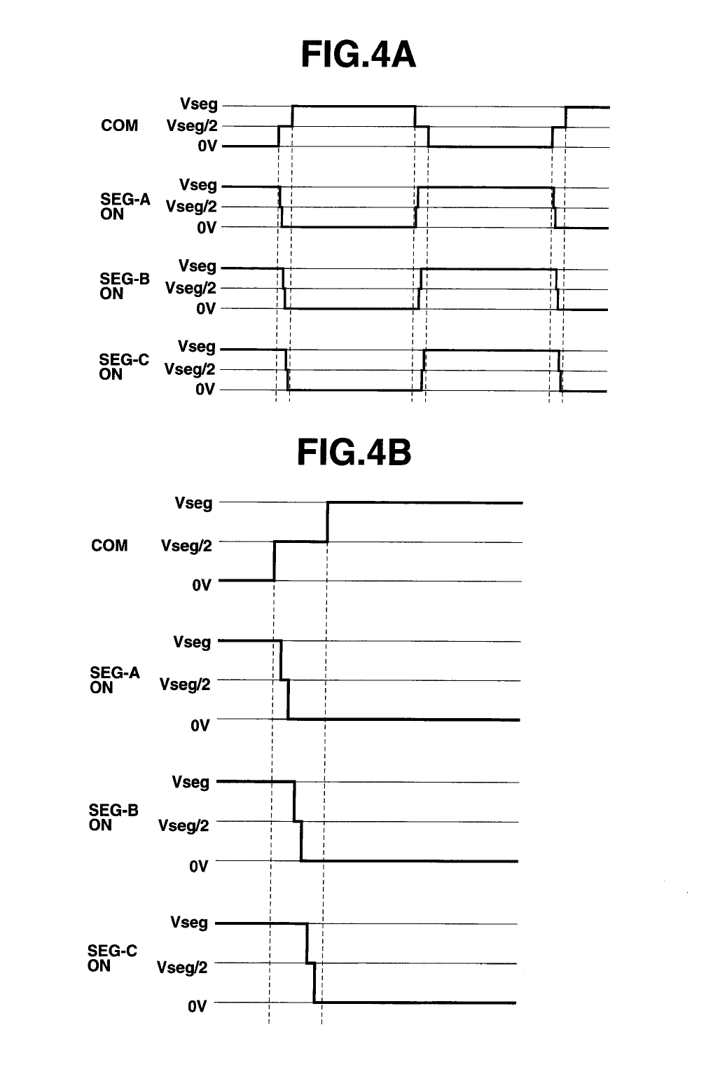

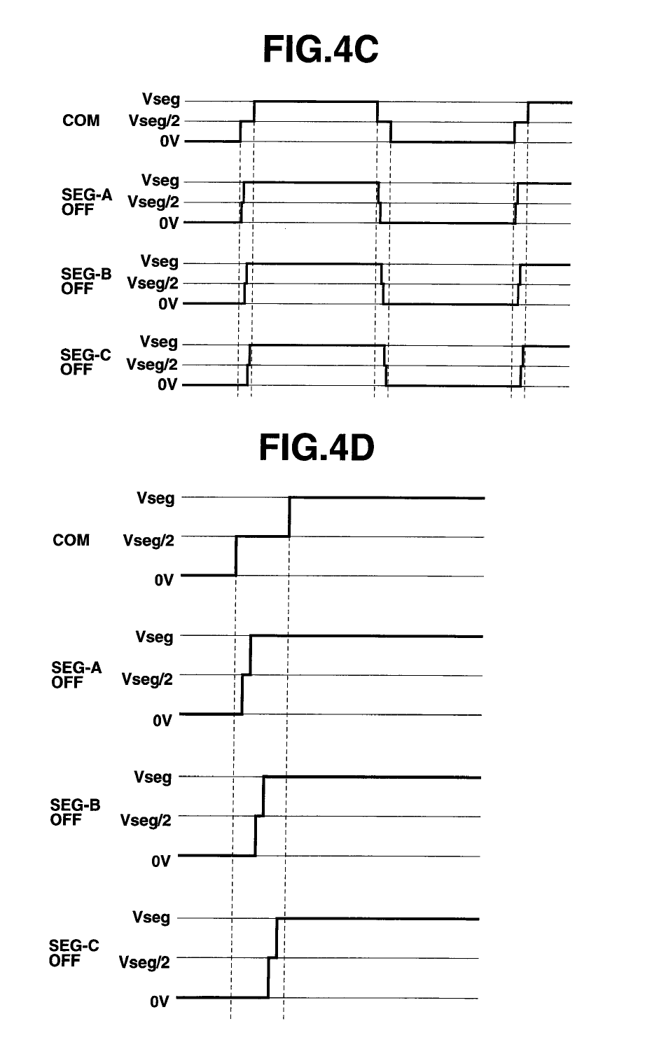

FIG. 4A, FIG. 4B, FIG. 4C, and FIG. 4D. Here, FIG. 4A is a timing chart showing applied voltage waveforms during display-on in a PN liquid crystal driving apparatus and driving method according to this second embodiment, and FIG. 4B is a partially enlarged view of

FIG. 4A. Furthermore, FIG. 4C is a timing chart showing applied voltage waveforms during display-off in the PN liquid crystal driving apparatus and driving method according to the second embodiment, and FIG. 4D is a partially enlarged view of FIG. 4C.

In addition to the driving method according to the first embodiment, an actuation driver 23 as a PN liquid crystal driving apparatus according to this embodiment performs driving to output an intermediate level (Vseg/2) having the same voltage as that of the common electrode driving waveform COM during both or one of level switching from 0 V as the first level to a voltage Vseg as the second level and level switching from voltage Vseg as the second level to 0 V as the first level even in segment electrode waveforms SEG-A, SEG-B, and SEG-C in each group.

That is, in display-on (transparent state), as shown in FIG. 4A and FIG. 4B, at a level switching timing for switching the common electrode driving waveform COM from 0 V as the first level to a voltage Vseg as the second level, the common electrode driving waveform COM is first switched from 0 V as the first level to voltage Vseg/2 as the intermediate level. Then, segment electrode waveform SEG-A is temporarily switched from voltage Vseg as the second level to voltage Vseg/2 as the intermediate level. Thereafter, segment electrode waveform SEG-A is switched from voltage Vseg/2 as the intermediate level to 0 V as the first level. Segment electrode waveforms SEG-B and SEG-C remain at voltage Vseg which is the second level while switching the level of this segment electrode waveform SEG-A. Then, segment electrode waveform SEG-B is temporarily switched from voltage Vseg as the second level to voltage Vseg/2 as the intermediate level. Thereafter, segment electrode waveform SEG-B is switched from voltage Vseg/2 as the intermediate level to 0 V as the first level. Segment electrode waveform SEG-A remains as 0 V which is the first level and segment electrode waveform SEG-C remains at voltage Vseg which is the second level while switching the level of this segment electrode waveform SEG-B. Subsequently, segment electrode waveform SEG-C is temporarily switched from voltage Vseg as the second level to voltage Vseg/2 as the intermediate level. Thereafter, segment electrode waveform SEG-C is switched from voltage Vseg/2 as the intermediate level to 0 V as the first level. Segment electrode waveforms SEG-A and SEG-B remain at 0 V which is the first level while switching the level of this segment electrode waveform SEG-C. After segment electrode waveforms SEG-A, SEG-B, and SEG-C are all switched to 0 V as the first level, the common electrode driving waveform COM is switched from voltage Vseg/2 as the intermediate level to voltage Vseg as the second level.

Further, after elapse of the predetermined cycle, at the next level switching timing for the common electrode driving waveform COM, the common electrode driving waveform COM is first switched from voltage Vseg as the second level to voltage Vseg/2 as the intermediate level. Then, segment electrode waveform SEG-A is temporarily switched from 0 V as the first level to voltage Vseg/2 as the intermediate level. Subsequently, segment electrode waveform SEG-A is switched from voltage Vseg/2 as the intermediate level to voltage Vseg as the second level. Segment electrode waveforms SEG-B and SEG-C remain at 0 V which is the first level while switching the level of this segment electrode waveform SEG-A. Then, segment electrode waveform SEG-B is temporarily switched from 0 V as the first level to voltage Vseg/2 as the intermediate level. Then, segment electrode waveform SEG-B is switched from voltage Vseg/2 as the intermediate level to voltage Vseg as the second level. Segment electrode waveform SEG-A remains at voltage Vseg which is the second level and segment electrode waveform SEG-C remains as 0 V which is the first level while switching the level of this segment electrode waveform SEG-B. Subsequently, segment electrode waveform SEG-C is temporarily switched from 0 V as the first level to voltage Vseg/2 as the intermediate level. Then, segment electrode waveform SEG-C is switched from voltage Vseg/2 as the intermediate level to voltage Vseg as the second level. Segment electrode waveforms SEG-A and SEG-B remain at the second voltage Vseg while switching the level of this segment electrode waveform SEG-C. After segment electrode waveforms SEG-A, SEG-B, and SEG-C are all switched to voltage Vseg as the second level in this manner, the common electrode driving waveform COM is switched from voltage Vseg/2 as the intermediate level to 0 V as the first level.

The above-described level switching operations are alternately carried out.

Further, in display-off (diffusing state), as shown in FIG. 4C and FIG. 4D, at a level switching timing for switching the common electrode driving waveform COM from 0 V as the first level to voltage Vseg as the second level, the common electrode driving waveform COM is first switched from 0 V as the first level to voltage Vseg/2 as the intermediate level. Then, segment electrode waveform SEG-A is temporarily switched from 0 V as the first level to voltage Vseg/2 as the intermediate level. Subsequently, segment electrode waveform SEG-A is switched from voltage Vseg/2 as the intermediate level to voltage Vseg as the second level. Segment electrode waveforms SEG-B and SEG-C remain at 0 V which is the first level while switching the level of this segment electrode waveform SEG-A. Then, segment electrode waveform SEG-B is temporarily switched from 0 V as the first level to voltage Vseg/2 as the intermediate level. Thereafter, segment electrode waveform SEG-B is switched from voltage Vseg/2 as the intermediate level to voltage Vseg as the second level. Segment electrode waveform SEG-A remains at voltage Vseg which is the second level and segment electrode waveform SEG-C remains as 0 V which is the first level while switching the level of this segment electrode waveform SEG-B. Thereafter, segment electrode waveform SEG-C is temporarily switched from 0 V as the first level to voltage Vseg/2 as the intermediate level. Then, segment electrode waveform SEG-C is switched from voltage Vseg/2 as the intermediate level to voltage Vseg as the second level. Segment electrode waveforms SEG-A and SEG-B remain at voltage Vseg which is the second level while switching the level of this segment electrode waveform SEG-C. After segment electrode waveforms SEG-A, SEG-B, and SEG-C are all switched to voltage Vseg as the second level, the common electrode driving waveform COM is switched from voltage Vseg/2 as the intermediate level to voltage Vseg as the second level.

Furthermore, after elapse of the predetermined cycle, at the next level switching timing for the common electrode driving waveform COM, the common electrode driving waveform COM is first switched from voltage Vseg as the second level to voltage Vseg/2 as the intermediate level. Then, segment electrode waveform SEG-A is temporarily switched from voltage Vseg as the second level to voltage Vseg/2 as the intermediate level. Subsequently, segment electrode waveform SEG-A is switched from voltage Vseg/2 as the intermediate level to 0 V as the first level. Segment electrode waveforms SEG-B and SEG-C remain at voltage Vseg which is the second level while switching the level of this segment electrode waveform SEG-A. Then, segment electrode waveform SEG-B is temporarily switched from voltage Vseg as the second level to voltage Vseg/2 as the intermediate level. Thereafter, segment electrode waveform SEG-B is switched from voltage Vseg/2 as the intermediate level to 0 V as the first level. Segment electrode waveform SEG-A remains as 0 V which is the first level and segment electrode waveform SEG-C remains at voltage Vseg which is the second level while switching the level of this segment electrode waveform SEG-B. Thereafter, segment electrode waveform SEG-C is temporarily switched from voltage Vseg as the second level to voltage Vseg/2 as the intermediate level. Subsequently, segment electrode waveform SEG-C is switched from voltage Vseg/2 as the intermediate level to 0 V as the first level. Segment electrode waveforms SEG-A and SEG-B remain at 0 V which is the first level while switching the level of this segment electrode waveform SEG-C. After segment electrode waveforms SEG-A, SEG-B, and SEG-C are all switched to 0 V as the first level, the common electrode driving waveform COM is switched from voltage Vseg/2 as the intermediate level to 0 V as the first level.

The above-described level switching operations are alternately performed.

Therefore, the actuation driver 23 is a PN liquid crystal driving apparatus that inputs each signal, which is switched between the first level and the second level in the predetermined cycle, to the common electrode 2 and the respective segment electrodes 4 of the plurality of PN liquid crystal display elements to perform static driving, and it functions as the PN liquid crystal driving apparatus that outputs to the respective segment electrodes 4 of the plurality of PN liquid crystal display elements each signal which is utilized to perform the level switching of each signal output to the segment electrode 4 of the PN liquid crystal display element included in one group and the level switching of each signal output to the segment electrode 4 of the PN liquid crystal display element included in another group at non-overlapping timings.

Moreover, in this second embodiment, this actuation driver 23 as the PN liquid crystal driving apparatus outputs for a predetermined time a signal state of the intermediate level between the first level and the second level from a signal state of the first or second level and then outputs a signal that enters a signal state of the second or first level as each signal output to the common electrode during the level switching for switching from the first level to the second level or from the second level to the first level, and performs the level switching of each signal output to the segment electrode when the signal output to the common electrode is in the signal state of the intermediate level. Additionally, the actuation driver 23 carries out at least either outputting for a predetermined time a signal state of the intermediate level between the first level and the second level from a signal state of the first level and then outputting a signal that enters a signal state of the second level as each signal output to the segment electrode during the level switching for switching from the first level to the second level, or outputting for a predetermined time the signal state of the intermediate level from the signal state of the second level and then outputting a signal that enters the signal state of the first level as each signal output to the segment electrode during the level switching from the second level to the first level.

Further, the PN liquid crystal panel 16 functions as a PN liquid crystal panel including: a liquid crystal panel glass 21 as a transparent substrate; a plurality of PN liquid crystal display elements formed on the transparent substrate; and the actuation driver 23 as a PN liquid crystal driving apparatus according to this embodiment that is COG-mounted on the transparent substrate.

Adopting such a PN liquid crystal driving method as that according to this second embodiment enables suppressing a current that flows during level switching of a driving waveform in a static driving system and also suppressing electro-current concentration, thereby reducing a drop of a driving voltage due to a large current during the level switching. Therefore, since a voltage that is sufficient to provide a desired display state can be applied to the PN liquid crystal display element, the narrow-frame PN liquid crystal panel having the actuation driver 23 formed as an LSI COG-mounted on the liquid crystal panel glass 21 can be manufactured.

Further, when the common electrode driving waveform COM is temporarily output to the intermediate level, effective voltages during level switching of the driving waveforms can be uniformed in the respective groups.

### Third Embodiment

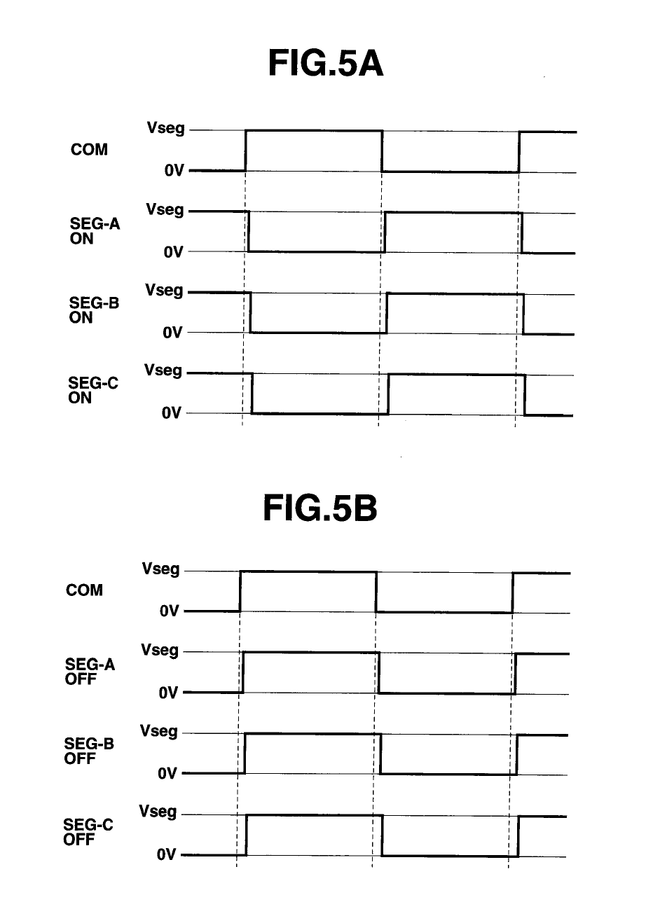

A third embodiment according to the present invention will now be described with reference to FIG. 5A and FIG. 5B. Here, FIG. 5A is a timing chart showing applied voltage waveforms during display-on in a PN liquid crystal display apparatus and driving method according to this third embodiment, and FIG. 5B is a timing chart likewise showing applied voltage waveforms during display-off.

In this embodiment, a common electrode driving waveform COM that is applied to a common electrode 2 is a square wave whose minimum value is 0 V (ground voltage) as the first level and whose maximum value is a voltage Vseg (e.g., 5 V) as the second level as in the conventional example.

Furthermore, many PN liquid crystal display elements arranged in a display unit 22 are divided into two or more groups (three groups A to C in this embodiment), and an actuation driver 23 as a PN liquid crystal driving apparatus performs level switching, which is level switching of segment electrode waveforms SEG-A, SEG-B, and SEG-C applied to the segment electrodes 4 in the respective groups from 0 V as the first level to voltage Vseg as the second level and level switching of the same from voltage Vseg as the second level to 0 V as the first level in such a manner that timings for the respective groups do not overlap each other.

That is, in display-on (transparent state), as shown in FIG. 5A, at a timing of level switching for switching the common electrode driving waveform COM from 0 V as the first level to voltage Vseg as the second level, the common electrode driving waveform COM is first switched from 0 V as the first level to voltage Vseg as the second level. Then, segment electrode waveform SEG-A is switched from voltage Vseg as the second level to 0 V as the first level. At this time, segment electrode waveforms SEG-B and SEG-C remain at voltage Vseg which is the second level. Subsequently, segment electrode waveform SEG-B is switched from voltage Vseg as the second level to 0 V as the first level. At this time, segment electrode waveform SEG-A remains as 0 V which is the first level, and segment electrode waveform SEG-C remains at voltage Vseg which is the second level. Thereafter, segment electrode waveform SEG-C is switched from voltage Vseg as the second level to 0 V as the first level. At this time, segment electrode waveforms SEG-A and SEG-B remain at 0 V which is the first level. In this manner, segment electrode waveforms SEG-A, SEG-B, and SEG-C are all switched to 0 V which is the first level.

Moreover, after elapse of the predetermined cycle, at the next level switching timing for the common electrode driving waveform COM, the common electrode driving waveform COM is first switched from voltage Vseg as the second level to 0 V as the first level. Then, segment electrode waveform SEG-A is switched from 0 V as the first level to voltage Vseg as the second level. At this time, segment electrode waveforms SEG-B and SEG-C remain at 0 V which is the first level. Subsequently, segment electrode waveform SEG-B is switched from 0 V as the first level to voltage Vseg as the second level. At this time, segment electrode waveform SEG-A remains at voltage Vseg which is the second level, and segment electrode waveform SEG-C remains as 0 V which is the first level. Thereafter, segment electrode waveform SEG-C is switched from 0 V as the first level to voltage Vseg as the second level. At this time, segment electrode waveforms SEG-A and SEG-B remain at voltage Vseg which is the second level. In this manner, segment electrode waveforms SEG-A, SEG-B, and SEG-C are all switched to voltage Vseg as the second level.

The above-described polarity switching operations are alternately carried out.

Additionally, in display-off (diffusing state), as shown in FIG. 5B, at a level switching timing for switching the common electrode driving waveform COM from 0 V as the first level to voltage Vseg as the second level, the common electrode driving waveform COM is first switched from 0 V as the first level to voltage Vseg as the second level. Then, segment electrode waveform SEG-A is switched from 0 V as the first level to voltage Vseg as the second level. At this time, segment electrode waveforms SEG-B and SEG-C remain at 0 V which is the first level. Subsequently, segment electrode waveform SEG-B is switched from 0 V as the first level to voltage Vseg as the second level. At this time, segment electrode waveform SEG-A remains at voltage Vseg which is the second level, and segment electrode waveform SEG-C remains as 0 V which is the first level. Thereafter, segment electrode waveform

SEG-C is switched from 0 V which is the first level to voltage Vseg which is the second level. At this time, segment electrode waveforms SEG-A and SEG-B remain at voltage Vseg which is the second level. In this manner, segment electrode waveforms SEG-A, SEG-B, and SEG-C are all switched to voltage Vseg as the second level.

Further, after elapse of the predetermined cycle, at the next level switching timing for the common electrode driving waveform COM, the common electrode driving waveform COM is first switched from voltage Vseg as the second level to 0 V as the first level. Then, segment electrode waveform SEG-A is switched from voltage Vseg as the second level to 0 V as the first level. At this time, segment electrode waveforms SEG-B and SEG-C remain at voltage Vseg which is the second level. Then, segment electrode waveform SEG-B is switched from voltage Vseg as the second level to 0 V as the first level. At this time, segment electrode waveform SEG-A remains as 0 V which is the first level, and segment electrode waveform SEG-C remains at voltage Vseg which is the second level. Thereafter, segment electrode waveform SEG-C is switched from voltage Vseg as the second level to 0 V as the first level. At this time, segment electrode waveforms SEG-A and SEG-B remain at 0 V which is the first level. In this manner, segment electrode waveforms SEG-A, SEG-B, and SEG-C are all switched to 0 V which is the first level.

The above-described level switching operations are alternately carried out.

Therefore, the actuation driver 23 is a PN liquid crystal driving apparatus that inputs each signal, which is switched between the first level and the second level in the predetermined cycle, to the common electrode 2 and the respective segment electrodes 4 of the plurality of PN liquid crystal display elements to perform static driving, and it functions as the PN liquid crystal driving apparatus that divides the plurality of PN liquid crystal display elements into two or more groups and outputs to the respective segment electrodes 4 of the plurality of PN liquid crystal display elements each signal which is utilized to perform at non-overlapping timings the level switching of each signal output to the segment electrode 4 of the PN liquid crystal display element included in one group and the level switching of each signal output to the segment electrode 4 of the PN liquid crystal display element included in another group.

Furthermore, the PN liquid crystal display panel 16 functions as a PN liquid crystal panel including: a liquid crystal panel glass 21 as a transparent substrate; a plurality of PN liquid crystal display elements formed on the transparent substrate; and the actuation driver 23 as a PN liquid crystal driving apparatus according to this embodiment that is COG-mounted on the transparent substrate.

Adopting such a PN liquid crystal driving method as that according to this third embodiment enables dispersing a current that flows during level switching of a driving waveform in a static driving system, namely, suppressing electro-current concentration, thereby reducing a drop of a driving voltage due to a large current during the level switching. Therefore, since a voltage that is sufficient to provide a desired display state can be applied to the PN liquid crystal display element, the narrow-frame PN liquid crystal panel having the actuation driver 23 formed as an LSI COG-mounted on the liquid crystal panel glass 21 can be manufactured.

In the first and second embodiments, the common electrode driving waveform COM is temporarily output to the intermediate level (Vseg/2) to uniform effective voltages at the timing of the level switching of each driving waveform in the respective groups. However, a level switching cycle for each driving waveform is, e.g., approximately 16 ms, whereas output of this intermediate level is finished in approximately 0.1 ms, and hence a difference in effective voltage between the respective groups that is produced during the level switching of the driving waveform does not affect the apparatus or display quality. Therefore, as in the first and second embodiments, outputting the intermediate level of the common electrode driving waveform COM is ideal. Actually, however, there is no problem even though the intermediate level is not output as in this embodiment.

As described above, in this embodiment, the actuation driver 23 as the PN liquid crystal driving apparatus no longer needs to include structures such as an amplifier that generates the intermediate level, thus achieving reduction in size of the LSI and in power consumption.

### Fourth Embodiment

Considering an example where such a PN liquid crystal panel 16 as described in the first to third embodiment is applied to a display in a viewfinder of a single-lens reflex camera, composition grid lines 17 or focus point indicators 18 are utilized when actually using the camera, and they are not required when the camera is not used. Therefore, it is desirable to eliminate indication of these members and set the viewfinder to a transparent state.

On the other hand, a PN liquid crystal display element must drive the above-described display-on to provide the transparent state. That is, even though a power supply of the camera is off when the camera is not used, a battery of the camera is utilized to drive the PN liquid crystal display element in order to set the viewfinder that is not used to the transparent state.

Thus, although the level switching of the driving waveform is performed with a frequency of approximately several tens of hertz to 100 Hz in the first to third embodiments, it is desirable to suppress power consumption in the actuation driver 23 as the PN liquid crystal driving apparatus by reducing this frequency to a ½ driving frequency or a lower frequency when the camera is not used, thereby achieving low power consumption of the camera.

It is to be noted that the present invention is not restricted to the foregoing embodiments, and its constituent elements can be modified and carried out on an embodying stage without departing from the scope of the invention. For example, although voltage Vseg as the second level is 5 V and the number of groups is 3, they can be of course changed to other values. Moreover, the description has been given as to the example of display in the viewfinder of the single-lens reflex camera, but it is needless to say that the present invention can be applied to any other devices. It is to be noted that, in such a case, when all PN liquid crystal display elements are not set to the same display state, regular driving can be of course performed without effecting grouping or driving and control for delaying the switching timing in the embodiments.

Additionally, various inventions can be formed by appropriately combining a plurality of constituent elements disclosed in the embodiments. For example, when the problem described in the section “BACKGROUND OF THE INVENTION” can be solved and the effect of the invention can be obtained even though several constituent elements are eliminated from all constituent elements described in the embodiments, a configuration that does not have these constituent elements can be extracted as an invention.

What is claimed is:

1. A polymer network liquid crystal driving apparatus comprising:
means for dividing a plurality of polymer network liquid crystal display elements into two or more groups when inputting a signal, which is switched between a first level and a second level in a predetermined cycle, to a common electrode and respective segment electrodes of the plurality of polymer network liquid crystal display elements to be subjected to static driving; and
output means for outputting to the respective segment electrodes of the plurality of polymer network liquid crystal display elements a signal that performs at non-overlapping timings switching of the level of a signal which is output to the segment electrode of the polymer network liquid crystal element included in one group and switching of the level of a signal which is output to the segment electrode of the polymer network liquid crystal display element included in another group.

2. The apparatus according to claim 1, wherein the output means performs:
outputting a signal state of an intermediate level between the first level and the second level for a predetermined time from a signal state of the first or second level and then outputting a signal that enters the signal state of the second or first level as a signal that is output to the common electrode during level switching for switching from the first level to the second level or from the second level to the first level; and
switching the level of the signal that is output to the segment electrode when the signal that is output to the common electrode is in the signal state of the intermediate level.

3. The apparatus according to claim 2, wherein the output means performs at least one of:
outputting a signal state of the intermediate level between the first level and the second level for a predetermined time from a signal state of the first level and then outputting a signal that enters the signal state of the second level as a signal that is output to the segment electrode during level switching for switching from the first level to the second level, and
outputting a signal state of the intermediate level for a predetermined time from a signal state of the second level and then outputting a signal that enters the signal state of the first level as a signal that is output to the segment electrode during level switching for switching from the second level to the first level.

4. The apparatus according to claim 1 wherein the apparatus is COG-mounted on a transparent substrate having the plurality of polymer network liquid crystal display elements formed thereon.

5. The apparatus according to claim 2 wherein the apparatus is COG-mounted on a transparent substrate having the plurality of polymer network liquid crystal display elements formed thereon.

6. The apparatus according to claim 3 wherein the apparatus is COG-mounted on a transparent substrate having the plurality of polymer network liquid crystal display elements formed thereon.

7. A polymer network liquid crystal driving method comprising:
a step of dividing a plurality of polymer network liquid crystal display elements into two or more groups when inputting a signal, which is switched between a first level and a second level in a predetermined cycle, to a common electrode and respective segment electrodes of the plurality of polymer network liquid crystal display elements to be subjected to static driving; and
a timing control step of performing at non-overlapping timings switching of the level of a signal which is output to the segment electrode of the polymer network liquid crystal element included in one group and switching of the level of a signal which is output to the segment electrode of the polymer network liquid crystal display element included in another group as a signal that is output to the respective segment electrodes of the plurality of polymer network liquid crystal display element.

8. The method according to claim 7, wherein the timing control step includes:
a step of outputting a signal state of an intermediate level between the first level and the second level for a predetermined time from a signal state of the first or second level and then outputting a signal that enters the signal state of the second or first level as a signal that is output to the common electrode during level switching for switching from the first level to the second level or from the second level to the first level; and
a step of switching the level of the signal that is output to the segment electrode when the signal that is output to the common electrode is in the signal state of the intermediate level.

9. The method according to claim 8, wherein the timing control step includes at least one of:
a step of outputting a signal state of the intermediate level between the first level and the second level for a predetermined time from a signal state of the first level and then outputting a signal that enters the signal state of the second level as a signal that is output to the segment electrode during level switching for switching from the first level to the second level, and
a step of outputting a signal state of the intermediate level for a predetermined time from a signal state of the second level and then outputting a signal that enters the signal state of the first level as a signal that is output to the segment electrode during level switching for switching from the second level to the first level.

10. A polymer network liquid crystal panel comprising:
a transparent substrate;
a plurality of polymer network liquid crystal display elements formed on the transparent substrate; and
a polymer network liquid crystal driving apparatus that inputs a signal, which is switched between a first level and a second level in a predetermined cycle, to a common electrode and respective segment electrodes of the plurality of polymer network liquid crystal display elements to be subjected to static driving,
wherein the polymer network liquid crystal driving apparatus divides the plurality of polymer network liquid crystal display elements into two or more groups, and outputs to the respective segment electrodes of the plurality of polymer network liquid crystal display elements a signal that performs at non-overlapping timings switching of the level of a signal which is output to the segment electrode of the polymer network liquid crystal element included in one group and switching of the level of a signal which is output to the segment electrode of the polymer network liquid crystal display element included in another group.

11. The polymer network liquid crystal panel according to claim 10, wherein the polymer network liquid crystal driving apparatus performs:
outputting a signal state of an intermediate level between the first level and the second level for a predetermined time from a signal state of the first or second level and then outputting a signal that enters the signal state of the second or first level as a signal that is output to the common electrode during level switching for switching from the first level to the second level or from the second level to the first level; and
switching the level of the signal that is output to the segment electrode when the signal that is output to the common electrode is in the signal state of the intermediate level.

12. The polymer network liquid crystal panel according to claim 11, wherein the polymer network liquid crystal driving apparatus performs at least one of:
outputting a signal state of the intermediate level between the first level and the second level for a predetermined time from a signal state of the first level and then outputting a signal that enters the signal state of the second level as a signal that is output to the segment electrode during level switching for switching from the first level to the second level, and
outputting a signal state of the intermediate level for a predetermined time from a signal state of the second level and then outputting a signal that enters the signal state of the first level as a signal that is output to the segment electrode during level switching for switching from the second level to the first level.

13. The polymer network liquid crystal panel according to claim 10, wherein the polymer network liquid crystal driving apparatus is COG-mounted on the transparent substrate.

14. The polymer network liquid crystal panel according to claim 11, wherein the polymer network liquid crystal driving apparatus is COG-mounted on the transparent substrate.

15. The polymer network liquid crystal panel according to claim 12, wherein the polymer network liquid crystal driving apparatus is COG-mounted on the transparent substrate.
